(19) United States
(12) Patent Application Publication
(10) Pub. No.: US 2009/0294013 A1
(43) Pub. Date: Dec. 3, 2009

(54) METHOD AND APPARATUS FOR PRODUCING COMPOSITE WORKS

(75) Inventor: Wayne Ernest Conrad, Hampton (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: 2089275 ONTARIO LTD., Richmond Hill, ON (CA)

(21) Appl. No.: 11/571,300

(22) PCT Filed: Oct. 18, 2005
(86) PCT No.: PCT/CA05/01578

§ 371 Date: Aug. 18, 2009

(51) Int. Cl. B44C 3/00; B44F 7/00; B44C 5/02; B42B 7/00

(52) U.S. Cl. 156/60

(57) ABSTRACT

A method of producing a publication, artwork or packaging (12) in which a thermoformable sheet (36) which has an image and or three dimensional profile is included therein The thermoformable sheet (36) is a non-cellulose based deformable substrate which is mounted to a mounting substrate (20) that is mounted to a frame (24) or included in the publication, artwork or packaging (12)

### FIELD OF THE INVENTION

This invention relates to the production of composite works, namely a work comprising an image substrate bearing a three-dimensional image that is associated with a mounting substrate. In one particularly preferred embodiment, the image substrate comprises a sheet of thermoformable plastic that has an image printed thereon and a relief topography provided therein wherein the thermoformable plastic sheet is attached to a cellulous sheet for mounting in a publication such as a book or magazine, or which is affixed to canvas for mounting on a frame.

### BACKGROUND OF THE INVENTION

It is known to produce art reproductions by printing an image on a thermoformable sheet and subsequently subjecting the thermoformable sheet to vacuum molding to provide topography in the image surface thereof. See for example U.S. Pat. Nos. 5,958,470 and 5,904,962. As shown in U.S. Pat. No. 5,904,962, the thermoformable sheet may bear a reproduction of an artwork. This sheet may be incorporated into a calendar or a greeting card. However, aside from such combinations, limited use has been made of thermoformable technology in the publishing industry.

### SUMMARY OF THE INVENTION

In accordance with the instant invention, a novel method of producing books, magazines and other publications are provided. While thermoformable plastic is pliable, it has a tendency to tear or rip if the thermoformable plastic is bent at other than a large radius. Therefore, printed thermoformable plastic has been limited in applications to its uses wherein the plastic extends essentially in a two-dimensional plane—such as by being mounted in a frame. Accordingly, in accordance with one embodiment of this invention, a thermoformable sheet is incorporated into a publication by associating the thermoformable sheet which has an image and/or a three dimensional profile produced therein, with paper or other sheets known in the art which are used in preparing publications (the mounting substrate). Accordingly, the mounting substrate is used to secure the image substrate in a publication. For example, in one particularly preferred embodiment, the image substrate may be an advertisement for a product. The mounting substrate may be a sheet of paper or the like and the publication is a magazine. Accordingly, in accordance with this invention, it is possible to mass produce magazines which have advertisements provided therein which are printed on thermoformable plastic and have a relief or topography provided in the thermoformable sheet (i.e. a three dimensional image). By using a mounting substrate, it is possible to incorporate three-dimensional advertisements or the like into publications using existing printing techniques.

Preferably, the image substrate is attached to the mounting substrate prior to the mounting substrate being incorporated into the publication. However, it will be appreciated that in an alternate embodiment, the image substrate may be affixed to the mounting substrate subsequent to the mounting substrate being incorporated into the publication.

The image substrate and the mounting substrate are a composite work that together form a “page” in the publication. A further advantage of the instant invention is that, by using a mounting substrate, both sides of the page may be utilized to contain articles, images or any other material routinely incorporated into a publication. For example, the image-bearing surface of the image substrate may have a picture, advertisement or the like provided therein. The opposite or rear surface of the image substrate contains the negative version of the topography provided in the image substrate and is accordingly less desirable for use. For example, it is less desirable to print text on the negative image side of an image substrate as the text may be difficult to read. Accordingly, in accordance with this aspect of the invention, a mounting substrate is affixed to the negative side of the image substrate. The side of the mounting substrate that is not affixed to the image substrate may have text, pictures or the like provided thereon. Accordingly, both sides of a “page” are utilized.

The image substrate may be removably affixed to the mounting substrate, such as by a releasable adhesive, which adhesives are known in the art. Alternately, or in addition, the mounting substrate and the image substrate together may be removably affixed to the publication. For example, the mounting substrate may have perforations or a score line provided therein so as to permit the mounting substrate, which has the image substrate provided thereon, to be removed or torn out of a magazine. This particular embodiment may be utilized if the image substrate contains a coupon, or the like.

In an alternate embodiment, the composite work could be utilized as the cover of a publication.

Accordingly, in accordance with this aspect of the instant invention there is provided method for producing a composite product comprising:
(a) providing an image substrate bearing an image;
(b) providing a mounting substrate having at least first and second portions and applying the image substrate to at least part of the first portion of the mounting substrate; and,
(c) using the mounting substrate to incorporate the image substrate into a publication having a plurality of pages that are secured as a unit.

In one embodiment, the method further comprises providing a three dimensional image in the image substrate.

In another embodiment, the method further comprises using the second portion of the mounting substrate to incorporate the mounting substrate to the publication.

In another embodiment, the method further comprises securing the mounting substrate and the pages together to form the publication.

In another embodiment, the method further comprises using an adhesive, an elongate member or a combination thereof to secure the secure the pages and the mounting substrate together.

In another embodiment, the publication includes a cover and the method further comprises positioning the mounting substrate interior of the cover.

In another embodiment, the publication includes a cover and the method further comprises positioning the mounting substrate as at least a portion of the cover of the publication.

In another embodiment, the method further comprises selecting at least one of metal and plastic as the image substrate.

In another embodiment, the method further comprises selecting plastic as the image substrate.

In another embodiment, the method further comprises selecting at least one of cellulose or canvas as the mounting substrate.

In another embodiment, the method further comprises selecting cellulose as the mounting substrate and the publication comprises a magazine or a book.

In another embodiment, the method further comprises removably applying the image substrate to the mounting substrate.

In another embodiment, the method further comprises applying the image substrate to the mounting substrate such that, once the publication is formed, a least part of the image substrate is removable from the mounting substrate.

In accordance with another embodiment of the instant invention, the composite work could comprise artwork or an art reproduction. In particular, the image substrate may comprise a thermoformable sheet having a two-dimensional image printed thereon and, preferably, a three-dimensional image formed therein. For example, the image could be a reproduction of an original artwork, movie poster, advertisement or the like. The image substrate may be secured to a mounting substrate and the mounting substrate used to mount the image substrate on a frame. One advantage of this embodiment of the invention is that the image substrate may be maintained planer (i.e. it need not be bent around a frame or otherwise deformed so as to be secured to a frame) thereby reducing or preventing rips, tears or the like to occur in the substrate.

Accordingly, in accordance with this aspect of the instant invention there is provided a method comprising:
(a) providing an image substrate bearing an image;
(b) providing a mounting substrate having at least first and second portions and applying the image substrate to at least part of the first portion of the mounting substrate; and,
(c) using the mounting substrate to mount the image substrate on a frame.

In one embodiment, the method further comprises providing a three dimensional image on the image substrate.

In another embodiment, the method further comprises using the second portion of the mounting substrate to incorporate the mounting substrate to the frame.

In another embodiment, the method further comprises selecting at least one of metal and plastic as the image substrate.

In another embodiment, the method further comprises selecting plastic as the image substrate.

In another embodiment, the method further comprises selecting at least one of cellulose or canvas as the mounting substrate.

In another embodiment, the method further comprises selecting canvas as the mounting substrate and the three-dimensional image comprises an artwork.

In another embodiment, the mounting substrate has a plurality of second positions spaced around the first portion and the method further comprises using the second portions to mount the image substrate on the frame.

In accordance with another aspect of the instant invention, the image substrate may be incorporated into or used as packaging. For example, an image substrate may be provided as part or all of the packaging of a product. For example, the mounting substrate may be a panel of the packaging of a product (e.g. the panel of a cardboard box) which has a window provided therein. The image substrate may be mounted to fill the window. Alternately, the image substrate may be secured to all or a portion of the outside of the packaging of a product. Preferably, the image substrate is at least translucent and, preferably, is transparent (i.e., is formed from a clear plastic which may have an image printed thereon). Accordingly, part of the product may be visible through the image substrate. Alternately, the image substrate may have a three dimensional image provided therein and the image substrate may be utilized to form the packaging of a product (e.g. a bubble wrap for a product).

In accordance with this embodiment of the invention, there is provided a method of producing packaging of a product comprising:
(a) providing an image substrate bearing an image formed therein; and,
(b) mounting the image substrate on a mounting substrate to produce a composite product
   wherein the mounting substrate is incorporated in the packaging of a product and has an opening and the image substrate is positioned over the opening.

In one embodiment, the method further comprises providing a three dimensional image in the image substrate.

In another embodiment, the method further comprises selecting a plastic as the image substrate and a cellulose-based material as the mounting substrate.

In another embodiment, the method further comprises selecting a clear plastic as the image substrate and cardboard as the mounting substrate.

In another embodiment, the method further comprises providing an image on the image substrate.

In another embodiment, the method further comprises providing an image on the image substrate prior to mounting the substrate on the mounting substrate.

In another embodiment, the method further comprises selecting at least one panel of the packaging as the mounting substrate.

In another embodiment, the image substrate is at least translucent and the method further comprises positioning a portion of the product so that the portion of the product is visible through the image substrate.

In another embodiment, the method further comprises selecting a clear plastic as the image substrate.

In accordance with this embodiment of the invention, there is also provided a method of producing packaging of a product comprising:
(a) providing an image on a three dimensional image substrate; and,
(b) forming a three dimensional profile in the image substrate.

In one embodiment, the method further comprises selecting a plastic as the image substrate.

In another embodiment, the method further comprises selecting a clear plastic as the image substrate and cardboard as the mounting substrate.

In another embodiment, the image substrate is at least translucent and the method further comprises positioning a portion of the product so that the portion of the product is visible through the image substrate.

In another embodiment, the method further comprises selecting a clear plastic as the image substrate.

### BRIEF DESCRIPTION OF THE DRAWINGS

These and other advantages of the instant invention will be more fully and completely understood in association with the following description of the preferred embodiments of the invention in which:

FIG. 1 is a perspective view of a publication which is open to display a page comprising a composite work;

FIG. 2 is a cross-section along the line 2-2 in FIG. 1;

FIG. 3 is an exploded view of a composite work according to an embodiment of the instant invention.

FIG. 3A is a side view of the exploded view of the composite work of FIG. 3;

FIG. 4 is an exploded view of an alternate composite work according to an alternate embodiment of the instant invention;

FIG. 4A is a side view of the exploded composite work of FIG. 4;

FIG. 5 is an exploded view of packaging according to another embodiment of the instant invention;

FIG. 6 is the completed packaging which is shown in exploded view in FIG. 5;

FIGS. 7 and 7A show a method of assembling a composite work according to another embodiment of the instant invention; and,

FIGS. 8 and 8A show a method of assembling a cover page for a book using a composite work according to an embodiment of the instant invention.

### DETAILED DESCRIPTION OF THE INVENTION

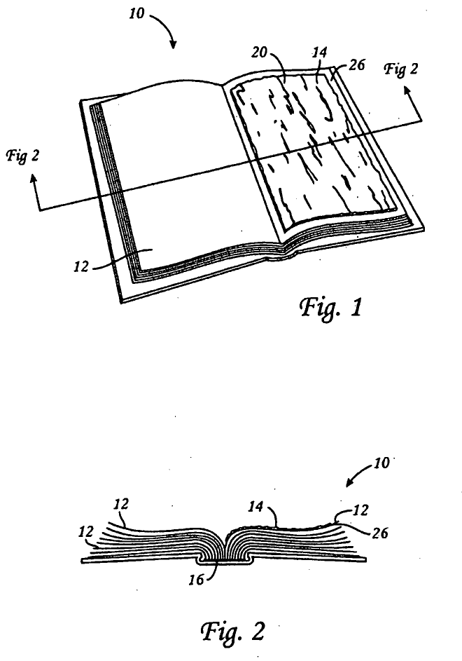

In accordance with one aspect of the instant invention, as exemplified in FIGS. 1 and 2, a publication 10 has a plurality of pages 12. At least one of the pages 12 comprises a composite work 14. Pages 12, including the one or more composite works 14, are secured together by binding 16.

Publication 10 may be any publication that contains a plurality of pages. For example, publication 10 may be a book (which may be a hard cover as shown in FIG. 1, or a soft cover book). In addition, publication 10 could be a magazine, scientific or technical journal, calendar, day timer, newspaper, post card, greeting card or the like, and preferably bound publication such as a magazine, scientific or technical journal. Examples of such publications include business journals, medical journals, annual company reports, works of fiction and non-fiction, art books, instructional manuals, and posters.

It will be appreciated that the type of binding 16 that is utilized may vary depending upon the type of publication. For example, in the case of a magazine, the publication may be secured by staples. Alternately, in the case of a book, the pages may be secured together by an adhesive, stitching, mechanical binding with spirals or combs or combinations thereof, Any binding means known in the art may be used. In a preferred embodiment, the binding includes an elongate member, such as staples or stitching, which passes through the composite work 14.

As shown in FIG. 2, publication 10 includes one composite work 14. It will be appreciated that a plurality of pages of publication 10 may comprise composite works. In an alternate embodiment, it will be appreciated that every page of publication 10 may be a composite work 14.

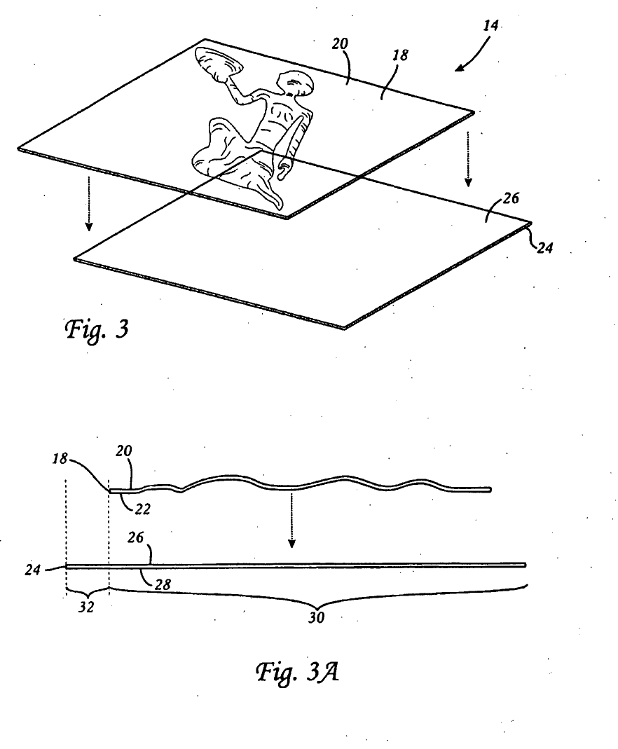

As shown in FIGS. 3 and 3A, composite work 14 comprises an image substrate 18, which has an image bearing surface 20 and a rear surface 22, and a mounting substrate 24, which has a mounting surface 26 and a viewable surface 28.

Substrate 18 may be prepared by pressure forming, vacuum forming, pressure and vacuum forming, embossing, applying a variable mechanical force to the substrate so as to produce a plurality of depths in the Z dimension. The variable mechanical force may be produced by a printing head, such as a dot matrix printing head, a daisy wheel printing head, by a plurality of pins or an eclectic deformable LCD whereby a computer signal will result in a physically member contacting and depressing the substrate at different locations. Preferably, substrate 18 is prepared by pressure and/or vacuum forming.

Substrate 18 is preferably a plastic or metal and, more preferably, a thermoformable plastic. The thermoformable plastic is preferably poly vinyl chloride, polystyrene, neoprene, PET and, preferably, is PVC and, most preferably, is polystyrene. The metal is preferably aluminum or brass. One advantage of the use of neoprene is that neoprene may be reversibly deformable and, accordingly, can be reused in the process. If the substrate is an irreversibly deformable thermoplastic such as poly vinyl chloride or polystyrene. In such a case, the thermoformable plastic may be recycled by grinding the used substrate as is known in the art.

The thermoformable plastic substrate may have a thickness from 0.002-0.02 inches, preferably from 0.005-0.015 inches, more preferably from 0.008-0.012 inches. The metal substrate may have a thickness from 0.002 to 0.020 inches, preferably 0.004 to 0.012 inches and most preferably 0.005 to 0.008 inches.

Prior to the substrate being subjected to any of the forgoing processes, the rigidity of the substrate may be reduced such as by increasing the temperature of the substrate or the addition of a chemical additive. For example, polystyrene, poly vinyl chloride or ABS may be exposed to methyl ethyl ketone (MEK). The MEK results in the thermo-formable plastic temporarily softening thereby enhancing the molding operation.

Such processes and substrates are described in co-pending PCT application no. ______ entitled Method For The Automated Production Of Three-Dimensional Objects And Textured Substrates From Two-Dimensional Or Three-Dimensional Objects, the disclosure of which is incorporated herein by reference.

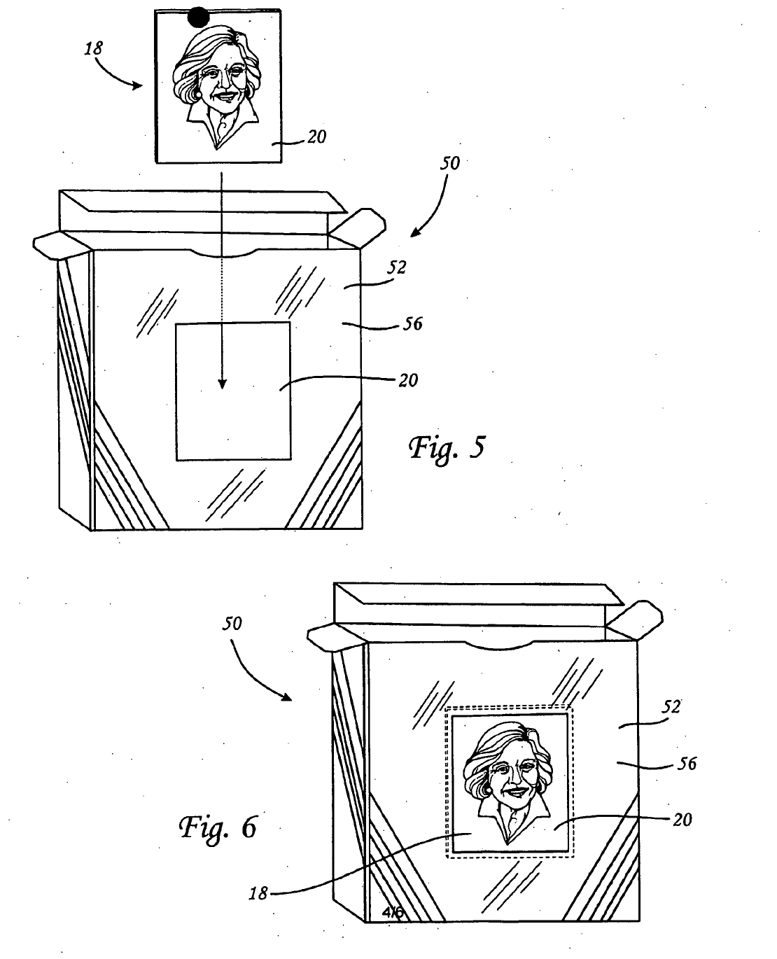

Mounting substrate 24 may be any material suitable for receiving image substrate 18. If composite work 14 is for use in a publication as exemplified in FIGS. 1, 2, 8 and 8A, then mounting substrate 24 may be any substrate suitable for inclusion as a page in publication 10. Preferably, mounting substrate 24 is cellulose based and, more preferably, is paper. It will be appreciated that mounting substrate 24 may be 8 to 100 pound weight paper or a paper mache. Alternately, if composite work 14 is for use in packaging as exemplified in FIGS. 5 and 6, then mounting substrate 24 may be cardboard of other rigid material suitable for use in packaging, such as plastic.

Image bearing surface 20 of image substrate 18 has an image provided therein. The image may be a two dimensional image, which may be prepared by printing an image on a thin plastic sheet. Preferably, image substrate 18 has a three-dimensional image formed therein. Accordingly, the substrate has a reproduction of an image wherein the image extends in the X, Y and Z planes. Such an image may be prepared by preparing a mold that contains a female version of the image and subjecting the substrate to vacuum and/or a pressure molding to form a male version of the image. Preferably, image bearing surface 20 is prepared by printing a two dimensional image on image bearing surface 20 and then forming a three dimensional image (a relief pattern) matching the image printed on image bearing surface 20.

Mounting substrate 24 is preferably planar (i.e., the substrate extends in the X, Y planes) as shown in FIGS. 3 and 3A and has a rear surface 26 which may have text or other material printed thereon in known fashion. Mounting surface 26 is secured to image substrate 18 by any means known in the art. For example, rear surface 22 of substrate 18 may be secured to mounting surface 26 such as by means of an adhesive, such as 3M Fastbond. In an alternate embodiment, it will be appreciated that rear surface 22 may be removably affixed to mounting surface 26 such as by means of a releasable adhesive, such as guar gum based adhesive. Such an embodiment is particularly preferred if substrate 18 contains a coupon, such as those that are redeemably for a product, or entitles the bearer to a discounted price for a product.

In operation, each of image substrate 18 and mounting substrate 24 are preferably individually prepared. For example, a three dimensional image may be formed in image substrate 28 and text may be printed on viewable surface 28 of mounting substrate 24. The substrates may then be associated together to form composite work 14 and composite work 14 may then be incorporated into publication 10. Alternately, it will be appreciated that image substrate may be secured to mounting substrate 24 after mounting substrate has been secured in publication 10.

It will be appreciated that mounting substrate 24 has first and second portions 30, 32. First portion 30 is used to secure image substrate 18 to mounting substrate 24. Second portion 32 is used to secure mounting substrate 24 to publication 10. It will be appreciated that mounting substrate 24 may comprise a further page of publication 10. Accordingly, mounting substrate 24 may be sized so as to comprise two pages of publication 10, i.e., it may extend an equal distance on both sides of the binding of publication 10.

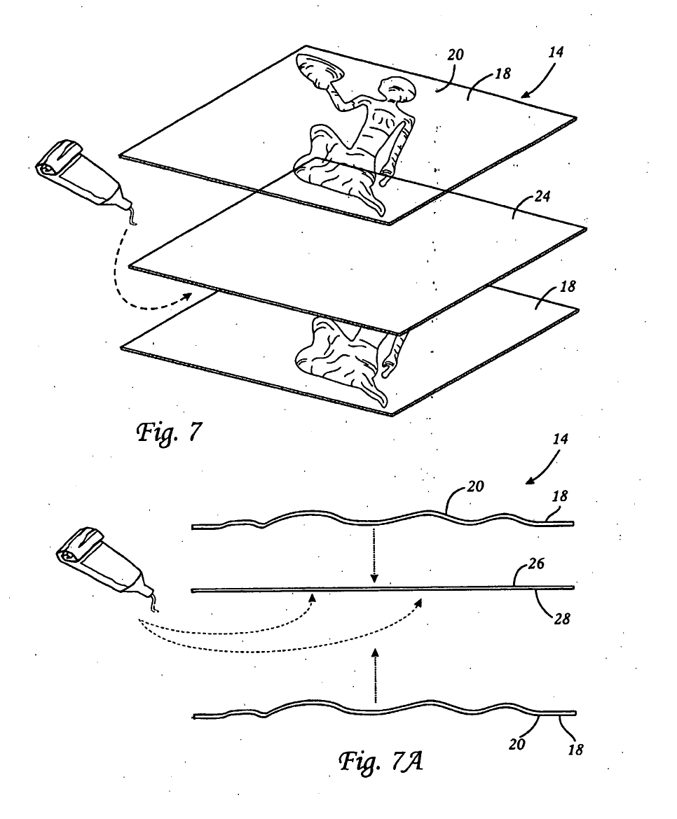

In an alternate embodiment, as exemplified in FIGS. 7 and 7A an image substrate 18 may be affixed to each of the opposed surfaces 26, 28 of mounting substrate 24. Thus composite work 14 may have two image bearing surfaces 20 that are essentially mounted back to back so as to form consecutive pages in publication 10.

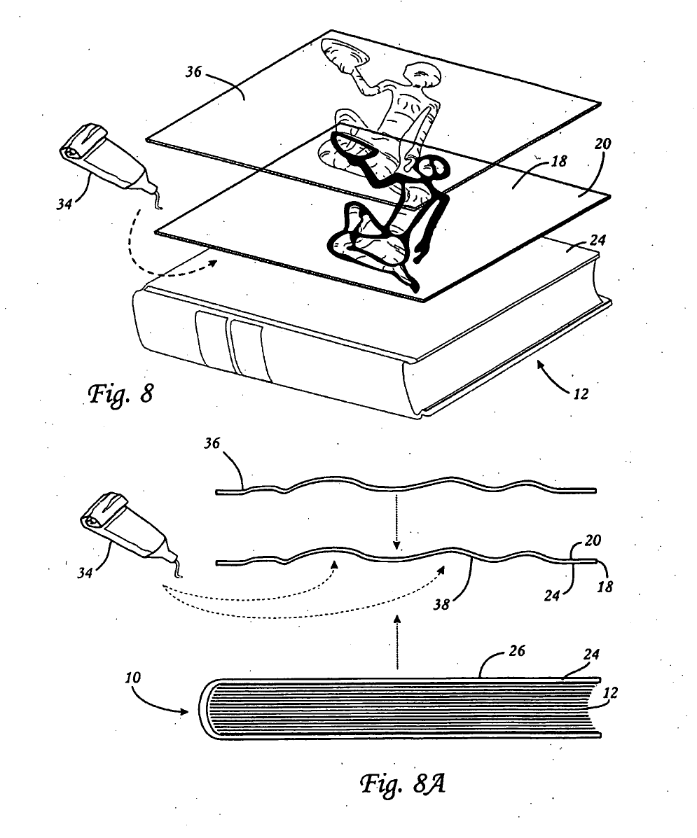

In one embodiment, composite work 14 comprises one or more pages interior of the publication 10 (i.e. between the cover of publication 10). In the alternate embodiment shown in FIGS. 8 and 8A, mounting substrate 18 provides part or all of the cover of publication 10. As shown therein, mounting substrate 18 is secured to the cover of a book, by means of an adhesive 24.

As shown in FIGS. 8 and 8A, optional cover sheet 36 is also utilized. As image substrate 18 will be provided on an exterior surface, cover sheet 36 may be provided to enhance the durability of image substrate 18. For example, cover sheet 36 may be a thin plastic sheet (i.e. it may have the same thickness as image substrate 18 or it may be thinner) and be secured over image substrate 18 by any means known in the art. As shown in FIGS. 8 and 8A, cover sheet 36 has the same profile or topography formed therein as is formed in image substrate 18. It will be appreciated that if image substrate 18 has a relatively low profile, or if sheet 36 is sufficiently thin and/or elastic, then cover sheet 36 need not be subjected to any pretreatment steps to provide a three-dimensional image therein but may merely be applied over image bearing surface 20 and conform to the topography of image bearing surface 20 as it is applied.

Due to the forming process, depressions 38 are formed in rear surface 24 of image substrate 18. These depressions form the negative image of the topography formed in image bearing surface 20. In order to enhance the durability of image substrate 18, depressions 38 may be filled, such as by filling depressions 38 with plaster, silicone, epoxy, or other non shrinking adhesive materials. Accordingly, essentially no hollow spaces may be provided between rear surface 24 of image substrate 18 and the cover of book 10. It will be appreciated that in a particularly preferred embodiment, depressions 38 may be filled and cover sheet 36 may be provided.

If cover sheet 36 is provided and/or depressions 38 are filled, then image substrate 18 need not be a load-bearing member. Accordingly, it need not be a thermoformable plastic. For example, in such a case, image substrate 18 could be a thin sheet of very thin plastic such as MYLAR. Alternately, image substrate 18 may be porous and may be cellulose based, such as paper or cardboard. In such a case, the substrate is preferably from 0.002-0.025 inches thick, more preferably 0.005-0.02 inches and, most preferably 0.008-0.015 inches thick. A substrate is preferably considered to be porous if it will allow a flow of more then 0.1 cubic inches of gas per square inches of substrate per minute therethrough when a vacuum of 25 inches of mercury apply to the substrate.

In order to enhance the pressure/vacuum molding of a porous substrate, a coating is preferably applied to the porous substrate or a nonporous substrate provided to make the porous substrate essentially gas impermeable so that it can be vacuum formed and/or pressure formed. The coating may be a compound such as ethylene vinyl acetate, which is applied to the paper or, alternately, a gas impermeable layer such as a thermoformable plastic, vapor deposited silicon monoxide or dioxide, or a thermoset plastic and may have a thickness of 0.0002 to 0.010 inches, more preferably 0.005 to 0.005 inches, and most preferably 0.001 to 0.003 inches. The porous substrate is preferably in intimate contact with a gas impervious layer (e.g., an elastomeric material such neoprene) such that pressure and/or vacuum may be applied to the cellulose based substrate such that the substrate is forced into intimate contact with a mold, thereby causing the cellulose based substrate to take on the shape of the mold, which may be a three dimensional representation of an original piece of art. The nonporous sheet also takes on the configuration of the surface of the mold during the molding operation and provides structural strength to the porous substrate to assist in durability of the resultant reproduction. Alternately, the nonporous sheet may be removable from the porous sheet once the porous sheet has been molded.

Alternately, if the substrate is cellulose based (e.g., paper or cardboard) the substrate may be exposed to steam prior to or during the molding process. It will be appreciated that an external heat source, such as electric heating coils, may be used in conjunction with steam to heat the cellulose based substrate and that the substrate may be exposed to water and then heated. Alternately, a cellulose base substrate could be coated with a polyester resin. The polyester resin will result in the cellulose-based substrate being temporarily more pliable. During the molding operation, if heat is applied, the resin will cure. As the resin cures, the substrate hardens. Accordingly, the use of a polyester resin or the like will result in a molded substrate wherein the image is more durable. Alternately, cellulose binders such as polyester resin could be utilized.

Accordingly, a paper substrate may be subjected to a pressure and/or vacuum molding to form a high-resolution topography. A resin may be applied to harden image substrate 18. Alternately, or in addition, depressions 18 and/or a cover sheet 36 may be used to increase the durability of a cellulose based image substrate 18.

In accordance with an alternate embodiment, it will be appreciated that composite work 14 may be an artwork, poster or the like suitable for display, such as mounting on a wall. In such a case, image substrate 18 may contain a re-production of artwork, such as disclosed in U.S. Pat. No. 5,904,962 or co-pending PCT patent application no. ______ entitled Method For The Automated Production Of Three-Dimensional Objects And Textured Substrates From Two-Dimensional Or Three-Dimensional Objects. Preferably mounting substrate 24 comprises canvas or other material suitable for insertion into a frame. The mounting substrate is secured to the frame and the image substrate is secured to the mounting substrate. Accordingly, art work suitable for framing may be secured to a frame without stapling or otherwise making holes in substrate 18 or deforming substrate 18 which can result in cracks, tears, propagating through substrate 18 thereby damaging the art work contained therein. Preferably, in such an embodiment, image substrate 18 is a thermoformable plastic. In a particularly preferred embodiment, canvas is first attached to a frame and stretched, or stretched and then attached to a frame. Image substrate 18 is then applied to the stretched canvas. For example, the mounting substrate 24 may be robotically wrapped around a stretcher frame and then secured to the frame such as by staples.

Accordingly, in such an embodiment, the first portion of the mounting substrate is used to receive image substrate 18. The second portion of the mounting substrate is used to secure composite work 14 to a frame. For example, if mounting substrate 24 is square or rectangular, then it may have four flanges around the perimeter of mounting substrate 24 wherein each flange comprises a second portion and is capable of being secured to a frame.

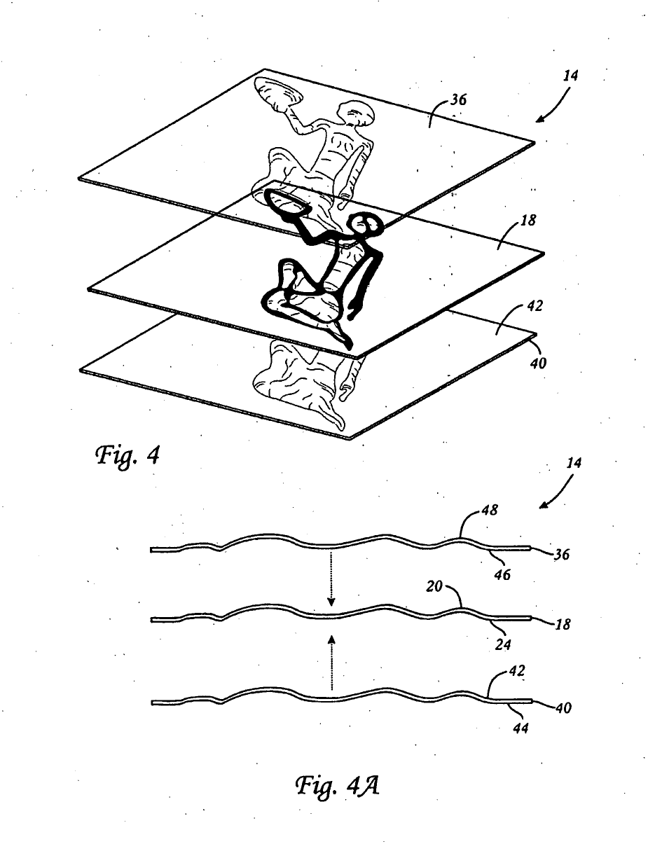

A further alternate embodiment is shown in FIGS. 4 and 4A. In FIGS. 4 and 4A, mounting substrate 18 is provided with both a cover sheet 36 having a mounting surface 46, for being secured to image bearing surface 20 of image substrate 18, and a top surface 48 and a bottom sheet 40 having a mounting surface 42, for being secured to rear surface 24 of image substrate 18, and a rear surface 44. Bottom sheet 40 may be secured or releasably secured to mounting sheet 18 by the same means used for cover sheet 36 or by a different means. As shown in FIG. 4A, cover sheet has the same image formed in it as image substrate 18 and as cover sheet 36. Accordingly, mounting surface 42 and rear surface 24 of image substrate 18 are in intimate contact. Preferably, each of cover sheet 36 and bottom sheet 40 form a material that can provide additional dimensional stability to image substrate 18. If image substrate 18 is cellulose based, then each of cover sheet 36 and bottom sheet 40 are preferably made of plastic thereby adding water resistance to image substrate 18. Accordingly, the composite work 14 shown in FIGS. 4 and 4A may be used in any application disclosed herein and, accordingly, may be secured to mounting substrate 24. Alternately, a composite work 14 as exemplified in FIGS. 4 and 4A may be used as trading cards (i.e., cards that contain a picture of a hockey player, basketball player, football player, etc. as well as information typically appearing on trading cards such as information about the player) wherein at least a portion of the material is provided in three-dimensions—e.g., the picture of the player may be a three-dimensional picture.

As shown in FIGS. 5 and 6, in a further alternate embodiment, image substrate 18 having an image on image bearing surface 20 may be used in packaging. Accordingly, the packaging may have a three-dimensional picture or artwork provided thereon.

For example, packaging 50 may comprise a plurality of panels, including front panel 52 having a window 54. Image substrate 18 is associated with window 54 so as to cover window 54. For example, image substrate 18 may be glued to outer surface 56 of outer panel 52 or, preferably, as shown in FIG. 5, is inserted into packaging 50 such that image bearing surface 20 is secured to packaging 50 by any means known in the art. It will be appreciated that image substrate 18 may be provided in more than one panel of packaging 50, may comprise or consist essentially of an entire panel of packaging 50, may be positioned at any location on a panel of packaging 50 and that a plurality of image substrates 18 may be provided on a single panel of packaging 50.

Packaging 50 may be constructed from plastic, cardboard, paper mache and, is preferably made from a cellulose-based material and, in particular, cardboard. While packaging 50 as shown in FIGS. 5 and 6 is a cardboard box, it will be appreciated that packaging 50 need not be a box but may be of any particular shape.

Preferably, opening 54 is positioned such that, when a product is placed in packaging 50, a portion of the product is visible through window 54. In such an embodiment, it is preferred that image substrate 18 comprises a plastic which is at least translucent and, preferably, is transparent (i.e., a clear plastic). A three dimensional image may be formed in image substrate 18. However, it will be appreciated that image substrate 18 may, in an alternate embodiment, have an image printed thereon and a three dimensional image formed therein. In either embodiment, it will be appreciated that a portion of the product may be visible through image substrate 18.

In an alternate embodiment, image substrate may have a three dimensional image formed therein. Image substrate 18 may be used to provide at least part, and optionally all of the packaging of an article. For example, a product may be packaged in bubble packaging, namely a package that is formed from plastic and surrounds a product, such as an action figure. Accordingly, the packaging may have a rear portion and a front portion. In such a case, the front panel of the packaging may comprise an image substrate and thereby have a three dimensional image formed therein. Accordingly, the incorporation of a three dimensional image into the bubble packaging may be used to enhance the packaging of a product. Preferably, in such an embodiment, the image substrate has an image printed thereon and a three dimensional image formed therein. Accordingly, the image substrate substantially enhances the attractiveness of the packaging of a product and enhances the likelihood that the product may be purchased by a consumer.

It will be understood that various additions and modifications may be made to the products and methods disclosed herein and each is within the scope of the following claims. In particular, it will be appreciated that each of the constructions herein may be used in any particular application disclosed herein.

1. A method for producing a composite product comprising:
a) providing an image substrate bearing an image;
b) providing a mounting substrate having at least first and second portions and applying the image substrate to at least part of the first portion of the mounting substrate; and,
c) using the mounting substrate to incorporate the image substrate into a publication having a plurality of pages that are secured as a unit.

2. The method of claim 1 further comprising providing a three dimensional image in the image substrate.

3. The method of claim 1 further comprising using the second portion of the mounting substrate to incorporate the mounting substrate to the publication.

4. The method of claim 1 further comprising securing the mounting substrate and the pages together to form the publication.

5. The method of claim 4 further comprising using an adhesive, an elongate member or a combination thereof to secure the secure the pages and the mounting substrate together.

6. The method of claim 1 wherein the publication includes a cover and the method further comprises positioning the mounting substrate interior of the cover.

7. The method of claim 1 wherein the publication includes a cover and the method further comprises positioning the mounting substrate as at least a portion of the cover of the publication.

8. The method of claim 1 further comprising selecting at least one of metal and plastic as the image substrate.

9. The method of claim 1 further comprising selecting plastic as the image substrate.

10. The method of claim 1 further comprising selecting at least one of cellulose or canvas as the mounting substrate.

11. The method of claim 1 further comprising selecting cellulose as the mounting substrate and the publication comprises a magazine or a book.

12. The method of claim 1 further comprising removably applying the image substrate to the mounting substrate.

13. The method of claim 1 further comprising applying the image substrate to the mounting substrate such that, once the publication is formed, a least part of the image substrate is removable from the mounting substrate.

14. A method comprising:
a) providing an image substrate bearing an image;
b) providing a mounting substrate having at least first and second portions and applying the image substrate to at least part of the first portion of the mounting substrate; and,
c) using the mounting substrate to mount the image substrate on a frame.

15. The method of claim 14 further comprising providing a three dimensional image on the image substrate.

16. The method of claim 14 further comprising using the second portion of the mounting substrate to incorporate the mounting substrate to the frame.

17. The method of claim 14 further comprising selecting at least one of metal and plastic as the image substrate.

18. The method of claim 14 further comprising selecting plastic as the image substrate.

19. The method of claim 14 further comprising selecting at least one of cellulose or canvas as the mounting substrate.

20. The method of claim 14 further comprising selecting canvas as the mounting substrate and the three-dimensional image comprises an artwork.

21. The method of claim 20 wherein the mounting substrate has a plurality of second positions spaced around the first portion and the method further comprises using the second portions to mount the image substrate on the frame.

22. A method of producing packaging of a product comprising:
a) providing an image substrate bearing an image formed therein; and,
b) mounting the image substrate on a mounting substrate to produce a composite product
wherein the mounting substrate is incorporated in the packaging of a product and has an opening and the image substrate is positioned over the opening.

23. The method of claim 22 further comprising providing a three dimensional image in the image substrate.

24. The method of claim 22 further comprising selecting a plastic as the image substrate and a cellulose-based material as the mounting substrate.

25. The method of claim 22 further comprising selecting a clear plastic as the image substrate and cardboard as the mounting substrate.

26. The method of claim 22 further comprising providing an image on the image substrate.

27. The method of claim 22 further comprising providing an image on the image substrate prior to mounting the substrate on the mounting substrate.

28. The method of claim 22 further comprising selecting at least one panel of the packaging as the mounting substrate.

29. The method of claim 22 wherein the image substrate is at least translucent and the method further comprises positioning a portion of the product so that the portion of the product is visible through the image substrate.

30. The method of claim 29 further comprising selecting a clear plastic as the image substrate.

31. A method of producing packaging of a product comprising:
a) providing an image on a three dimensional image substrate; and,
b) forming a three dimensional profile in the image substrate.

32. The method of claim 30 further comprising selecting a plastic as the image substrate.

33. The method of claim 30 further comprising selecting a clear plastic as the image substrate and cardboard as the mounting substrate.

34. The method of claim 30 wherein the image substrate is at least translucent and the method further comprises positioning a portion of the product so that the portion of the product is visible through the image substrate.

35. The method of claim 34 further comprising selecting a clear plastic as the image substrate.
